(19) United States
(12) Patent Application Publication
(10) Pub. No.: US 2010/0102584 A1
(43) Pub. Date: Apr. 29, 2010

(54) Portable, Collapsible Multiple Purpose Tool

(76) Inventor: Michael J. Sanchez, Denver, CO (US)

Correspondence Address: SHERIDAN ROSS PC, 1560 BROADWAY, SUITE 1200, DENVER, CO, 80202, US

(21) Appl. No.: 12/604,206

(22) Filed: Oct. 22, 2009

Related U.S. Application Data
(60) Provisional application No. 61/108,389, filed on Oct. 24, 2008.

(51) Int. Cl. E01H 6/00; E01H 5/02; E01H 1/02; A01B 1/20

(52) U.S. Cl. 294/51; 15/111

(57) ABSTRACT

A snow removal system is provided that is comprised generally of a handle that is selectively interconnectable to a shaft. The shaft is also interconnectable to either a shovel head or a broom head. The assembly is thus collapsible and easily stored within a vehicle or an automobile.

This application claims the benefit of U.S. Provisional Patent Application Ser. No. 61/108,389, filed Oct. 24, 2008, the entire disclosure of which is incorporated by reference herein.

### FIELD OF THE INVENTION

Embodiments of the present invention relate generally to a portable tool, which may have a collapsible shaft, with an interchangeable head portion. The head portion may be at least one of a brush, a shovel, an ice scraper, a squeegee and a broom. The collapsible nature of the tool allows it to be stored easily in an automobile.

### BACKGROUND OF THE INVENTION

Snow removal tools, such as shovels and brooms, are often unwieldy to use, carry or store. Thus, it is not convenient for an individual to carry or to store such bulky tools in their vehicle, as such tools usually will not fit within the confines of a vehicle trunk, for example. In addition, the infrequent need for such tools generally does not justify maintaining such tools in one's vehicle.

Thus it is a long felt need to provide a shovel and/or broom that is readily transported in one's vehicle. The remainder of the specification describes a multiple purpose tool that is collapsible or foldable and is easily stored in a vehicle.

### SUMMARY OF THE INVENTION

It is one aspect of the present invention to provide a tool that has a multiplicity of uses. More specifically, one embodiment of the present invention includes a handle that is received within a head portion. The head portion includes one or more mechanisms for interconnecting a first shovel half and second shovel half to the head portion to create a snow shovel. In one embodiment of the present invention, the head portion, first shovel half and second shovel half are interconnected via a sleeve that receives pins (i.e., similar to a door hinge). The pins may be of a curved shape to accommodate an arcuate shape of the head portion, first shovel half and second shovel half. Alternatively, the pins may be of flexible nature to selectively bend when being inserted into the arcuate shaped sleeves associated with the shovel. One skilled in the art will appreciate that other mechanisms for interconnecting the shovel halves to the head portion are contemplated by the present invention. For example, the portions may be snapped together or locked together by clips. Leading edges of the shovel halves and head portion may receive a protector component, made of preferably metal or other rigid material, to protect the edge of the shovel from damage when in use.

In some embodiments the handle interconnects to a smaller head portion that is adapted to receive a first broom half and a second broom half. Interconnection of the broom halves is similar to that as described above wherein a pin is used to interconnect adjacent halves to the head portion. Again, one skilled in the art will appreciate that other interconnection schemes are contemplated without departing from the scope of the invention. Similar to the shovel halves, the broom halves are adapted to receive a squeegee or ice scraper on a leading edge thereof. In operation, the ice scraper or squeegee is used initially, then the broom is used to sweep away the scraped off ice or excess snow.

It is another aspect of the present invention to provide a collapsible tool. Thus, embodiments of the present invention employ a foldable handle or a blade that breaks down into a plurality of segments. The segmented handle may be made of tubular segments that each include a spring-loaded ball that is received in an aperture of an adjacent segment. When the spring-loaded ball is aligned with the apertures, the balls are forced by the spring into a locked position. Other interconnection schemes, such as bayonet fittings or threads, for example, may be used without departing from the scope of the invention. The handle segments may employ an internally-located flexible band to facilitate reassembly of the same, similar to poles used in one or two person tents. The handle segments may also be selectively positionable relative to each other so an ergonomic, curved handle may be provided. For example, the handle segments may terminate in clevis fittings that are selectively interconnected by a fastener wherein the angle between respective segments may be maintained to provide an angled handle assembly. Furthermore, a telescoping handle may be used that includes individual segments that are tightened to their adjacent sections by a threaded connection or a coupling, for example.

It is thus another aspect of the present invention to provide a tool that is collapsible and fits into a small space. More specifically, embodiments of the present invention break down into three handle segments, two shovel halves, a shovel head portion, a broom head portion, two broom halves, two shovel pins, two broom pins, a front protector, a squeegee, an ice scraper and fit into a box or other container that is about 5.5 inches by about 8.5 inches by about 19 inches. Thus the entire system is well suited for storage in an individual's vehicle.

It is another aspect of the present invention to provide a shaft that is adapted to receive a handle portion and either a shovel blade or a broom. More specifically, one embodiment of the present invention is a three component system having a handle portion that includes a grip and a cavity for receiving an upper end of the shaft wherein the other portion of the shaft is received within a shovel or a broom. Preferably, the shaft is at least partially solid and includes spring loaded buttons that are received within apertures in the handle and the shovel or the broom. One of skill in the art will appreciate the handle may include a plurality of apertures to allow the user to selectively alter the length of the finished assembly. Although this embodiment of the present invention employs a single shaft, one of skill in the art will appreciate that the shaft may be severable, collapsible, or foldable as described above. Further, it is contemplated that the handle may be directly interconnected to an ice scraper or squeegee, without the shaft. Similarly, it is contemplated that the shovel blade may receive a stand or spike, for example, to allow it to be propped up to be used as a warning or distress signal, similar to orange cones or warning signs that are commonly found in vehicles. Further, the shaft may, by way of an adapter perhaps, to interface with the jack of a particular vehicle or lug nut wrench to aid in the use of those devices.

It is another aspect of the present invention to provide a collapsible tool comprising a shaft having a first end and a second end; a handle interconnected to said first end of said shaft; and a broom head associated with said second end of said shaft, said broom head comprising a planar surface with a forward edge, a rearward edge and opposing lateral edges therebetween, said forward edge further including an ice scraper.

It is yet another aspect of the present invention to provide a snow removal system, comprising a shaft having a first end and a second end; a handle interconnected to said first end of said shaft; a broom head for interconnection with said second end of said shaft, said broom head comprising an upper surface with a forward edge, a rearward edge and opposing lateral edges therebetween, said forward edge further including an ice scraper; and a shovel blade for interconnection with said second end of said shaft.

The Summary of the Invention is neither intended nor should it be construed as being representative of the full extent and scope of the present invention. The present invention is set forth in various levels of detail in the Summary of the Invention, in the attached drawings and in the Detailed Description. No limitation as to the scope of the present invention is intended by either the inclusion or non-inclusion of elements, components, etc. in this Summary of the Invention. Additional aspects of the present invention will be come more readily apparent from the Detailed Description of the Preferred Embodiment, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a front elevation view of an assembled shovel of one embodiment of the present invention;

FIG. 2 is an exploded view of FIG. 1;

FIG. 3 is a detailed view of a spring-loaded quick release mechanism for a handle segment;

FIG. 4 is a partial perspective view of the shovel assembly of FIG. 1;

FIG. 5 is a detailed view of a joint between shovel portions;

FIG. 6 is a cross-sectional view of a shovel blade with a protector/support interconnected thereto;

FIG. 7 is a front elevation view of a broom with a squeegee attachment and an ice scraper attachment;

FIG. 8 is a side elevation view showing the ice scraper of FIG. 7 interconnected to the broom;

FIG. 9 is a side elevation view of the broom with an ice scraper associated with the leading edge thereof;

FIG. 10 is a front elevation view of a shovel of another embodiment of the present invention;

FIG. 11 is a bottom plan view of the shovel at FIG. 10;

FIG. 12 is a top plan view of the shovel at FIG. 10;

FIG. 13 is a side elevation view of the shovel at FIG. 10;

FIG. 14 is a perspective view of the shovel at FIG. 10;

FIG. 15 is a perspective view of a handle of one embodiment of the present invention;

FIG. 16 is a front elevation view of the handle of FIG. 15;

FIG. 17 is a top plan view of the handle of FIG. 15;

FIG. 18 is a bottom plan view of the handle of FIG. 15;

FIG. 19 is a side elevation view of the handle of FIG. 15;

FIG. 20 is a cross-sectional view of FIG. 19;

FIG. 21 is a side elevation of a shaft of one embodiment of the present invention;

FIG. 22 is a side elevation view of FIG. 21;

FIG. 23 is a side elevation view of a shovel blade of one embodiment of the present invention;

FIG. 24 is a cross-sectional view of FIG. 23;

FIG. 25 is a side elevation view of a broom of one embodiment of the present invention;

FIG. 26 is a perspective view of a broom head shown in FIG. 25;

FIG. 27 is a bottom perspective view of the broom head of FIG. 26;

FIG. 28 is a top plan view of the broom head of FIG. 26;

FIG. 29 is a cross-sectional view of FIG. 28;

FIG. 30 is a cross-sectional view of FIG. 28;

FIG. 31 is a perspective view of an adapter used with the broom head of FIG. 26; and

FIG. 32 is a cross sectional view of FIG. 31.

To assist in the understanding of one embodiment of the present invention the following list of components and associated numbering found in the drawings is provided herein:

| # | Components |
|---|---|
| 2 | Shovel |
| 6 | Blade half |
| 8 | Blade |
| 10 | Head portion |
| 12 | Handle |
| 14 | Head segment |
| 18 | Leading edge |
| 22 | Protector support |
| 26 | Hinge |
| 30 | Pin |
| 34 | Coupling |
| 42 | Leading edge |
| 46 | Broom head |
| 50 | Broom half |
| 52 | Head portion |
| 54 | Ice scraper |
| 58 | Squeegee |
| 62 | Leading edge |
| 66 | Handle |
| 70 | Shaft |
| 74 | Blade |
| 78 | Coupling |
| 82 | Aperture |
| 86 | Ridge |
| 90 | Grips |
| 94 | Cavity |
| 98 | Leading edge |
| 102 | Side wall |
| 106 | Cavity |
| 110 | Broom head |
| 114 | Lip |
| 116 | Bristles |
| 118 | Ice scraper |
| 120 | Pin aperture |
| 122 | Upper surface |
| 126 | Recess |
| 130 | Clevis |
| 134 | Adapter |
| 138 | Pin |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION OF PREFERRED EMBODIMENT

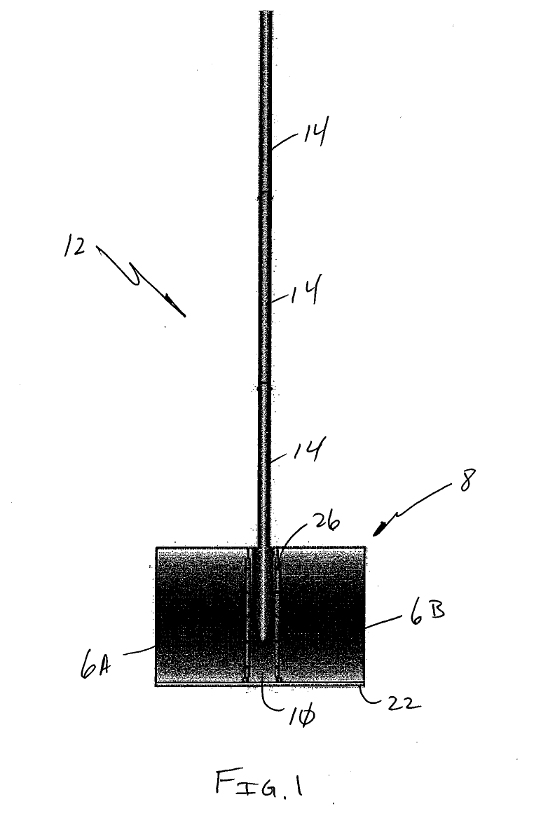

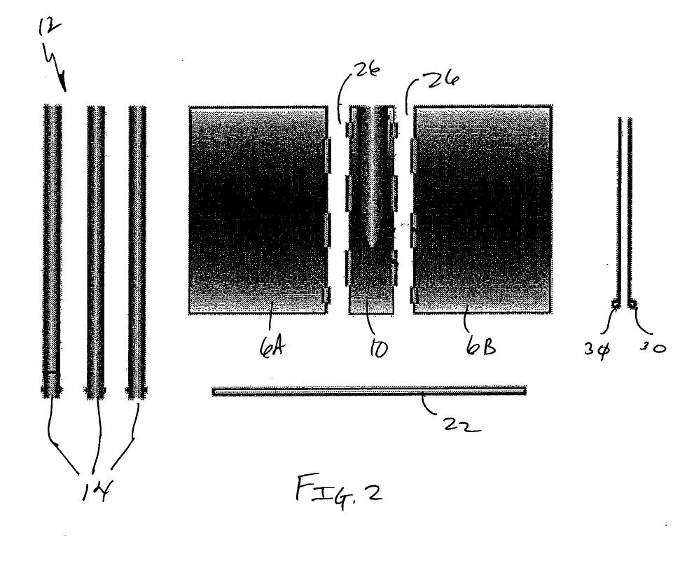

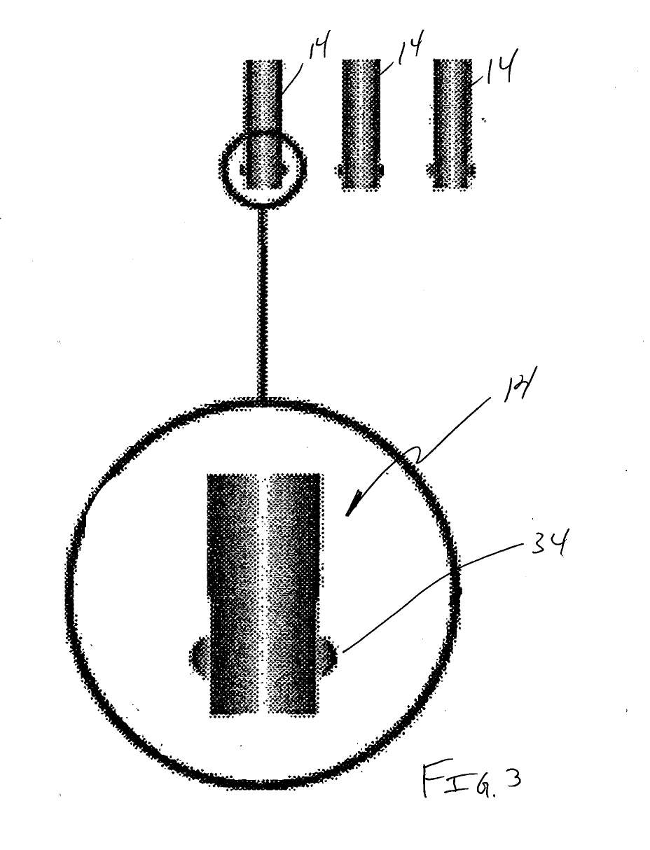

FIGS. 1-6 show an assembled shovel 2 with blade halves 6 that are assembled to a head portion 10. A handle 12, which is interconnected to the head portion 10, is comprised of three individual handle segments 14. The first blade half 6A and a second blade half 6B are interconnected to the head portion 10 to form a shovel head portion 10. A leading edge 18 of the assembled shovel 2 is protected by a front protector/support 22 that slides on the leading edge of the blade as depicted in FIG. 4. The first blade half 6a and the second blade half 6b are interconnected to the head portion by way of a stationary butt/mortise hinge 26 (i.e., similar to a door hinge).

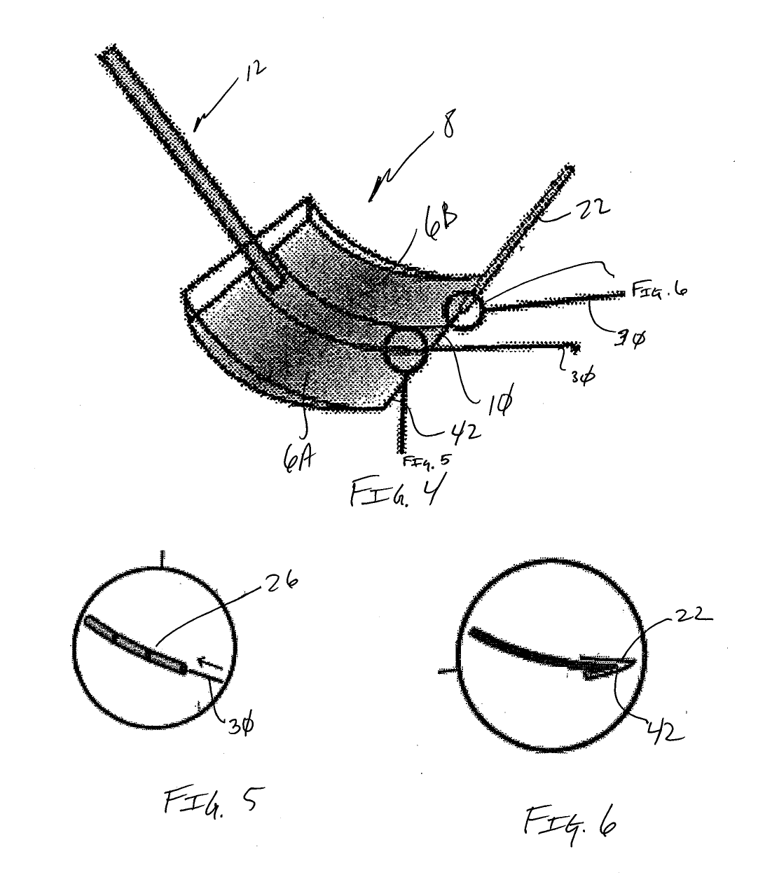

FIGS. 5 and 6 illustrate more specifically how the shovel blade is assembled. When the first blade section 6a the head portion 10 and the second blade portion 6b are assembled, the hinge components 26 fit together in a complimentary fashion. The hinge elements 26 are also spaced to accommodate the curvature of the shovel. A pin 30 is inserted into the hinge 26, which prevents the blade halves 6 from separating from the head portion 10. One of skill in the art will appreciate that the pins 30 may be somewhat flexible or curved to accommodate curved shovel portions. Other interconnection methods exist that can be used to securely assemble the blade halves to the head portion such as, for example, a mortise and tendon joint.

Referring specifically to FIG. 3, in one embodiment of the invention, the handle segments 14 are manufactured of a hollow, tubular metal or rigid plastic or composite that contain a quick release, spring loaded coupling 34 on a male end that is received within a female end of an adjacent segment 14. The spring loaded couplings 34 depicted in FIG. 3 are received into holes or depression of the female end. The head portion also receives a male end of the handle segment. A threaded interconnection may also be employed to associate adjacent handle segments 14. The handle segments 14 may alternatively be of a non-linear cross-sectional shape, may have one or more flat aspects, and may be solid. Additionally, the handle segments 14 need not necessarily be identical, for example, one of the handle segments may include a handle grip associated therewith.

Referring now to FIG. 4, a shovel blade 8 of one embodiment of the present invention is shown in conjunction with a protector/support 22. The protector/support 22, which is adapted to slide or snap onto a leading edge 42 of the blade 8 protects the leading edge 42 from damage and wear. The protector/support 22 may also be fastened to the leading edge 42 by way of at least one fastener, such as a screw. The protector/support 22 also provides support among the shovel portion by keeping the leading edge 42 substantially secure when subjected to uneven loading.

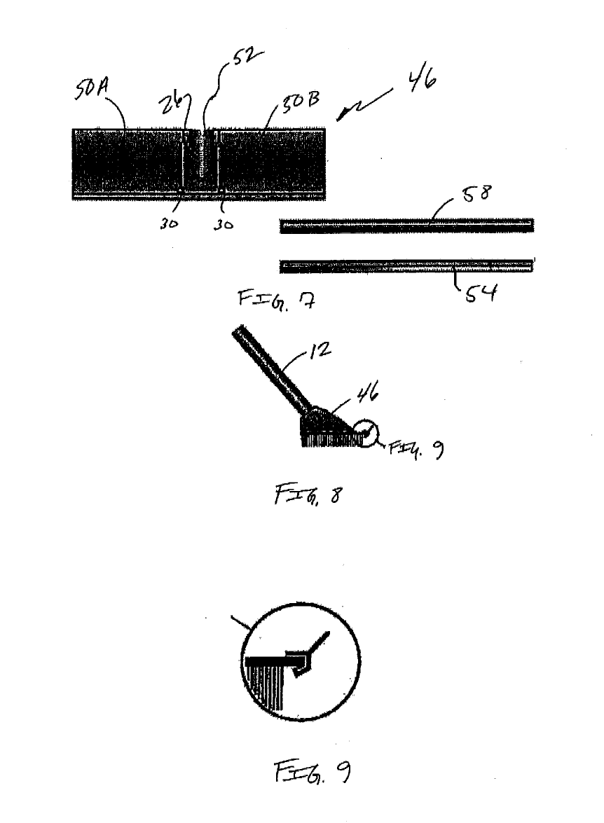

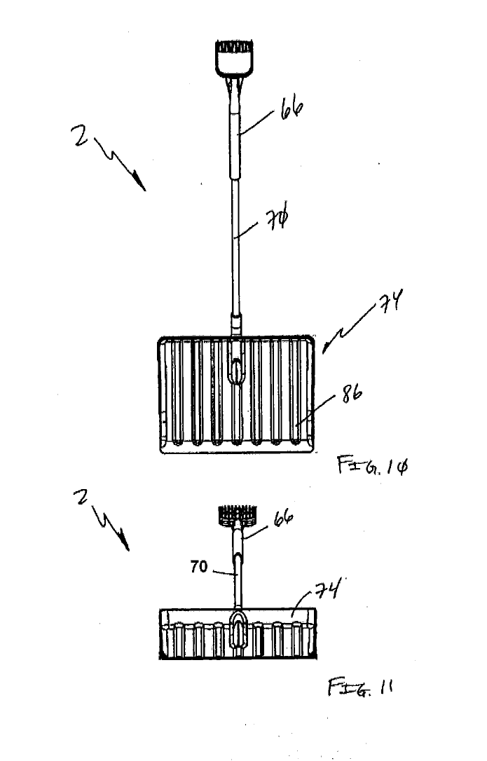

Referring now to FIG. 7, a broom head 46 is shown interconnected to the handle 12, thus illustrating the ability of the invention to have multiple attachments to enable the tool to be used for multiple tasks. The broom head 46 is similar to the shovel head portion of FIGS. 1-6 in that the broom head 46 receives a first broom half 50a and a second broom half 50b that are joined by way of a head portion 52, hinges 26 and pins 30. An ice scraper 54 or squeegee 58 is also provided that slides into a groove on a leading edge 62 of the broom head 46. FIG. 8 depicts a side elevation view of one embodiment of the present invention with the broom head portion assembled to the handle 12. FIG. 9 shows the ice scraper 54 or squeegee 58 that can either snap or slide onto a groove associated with the leading edge 62 of the broom head 46. Similar to the metal protector/support element that slides onto the leading edge of the shovel head portion, the ice scraper 54 and squeegee 58 provide support to the broom components.

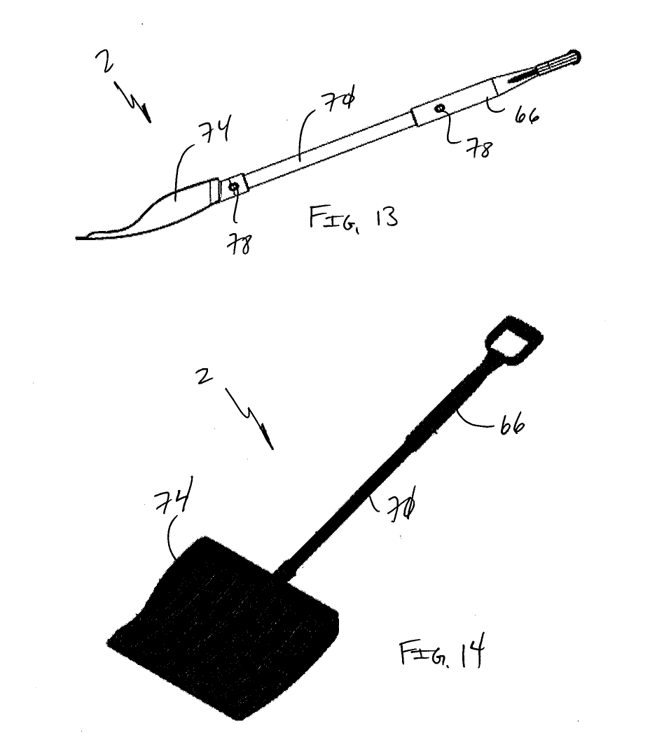

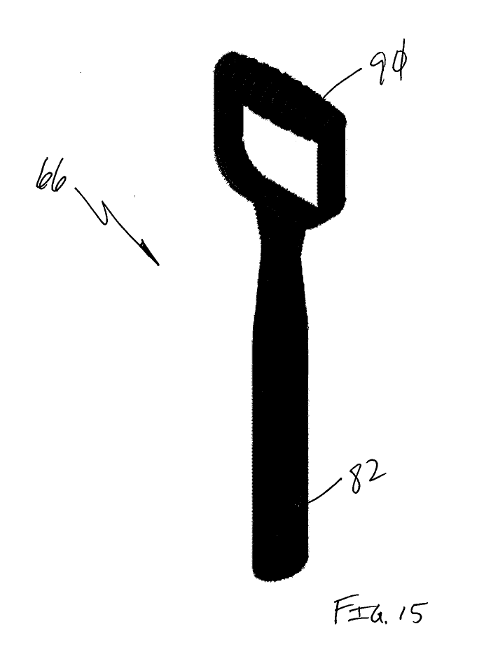

Referring now to FIGS. 10-14, another embodiment of a shovel is shown. Here, the shovel 2 is comprised of a handle 66, shaft 70 and blade 74. The blade 74 is of a one piece structure, however, one of skill in the art will appreciate that the shovel blade may be severable as described above with respect to FIGS. 1-6. In this embodiment of the present invention, the shaft 70 includes at least two spring loaded couplings 78 that are received within apertures 82 associated with the blade 74 and the handle 66. One skilled in the art will appreciate that the blade 74 and the handle 66 may include additional apertures to receive the coupling 78 to allow the length of the shovel to be selectively increased and decreased. The shovel blade 74 may additionally include a plurality of stiffening ridges 86.

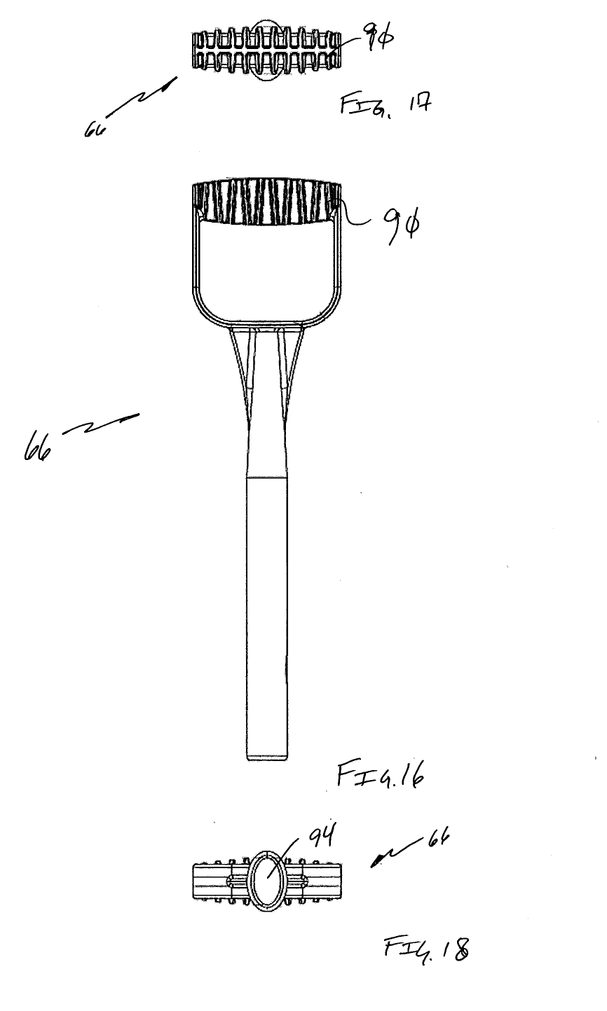

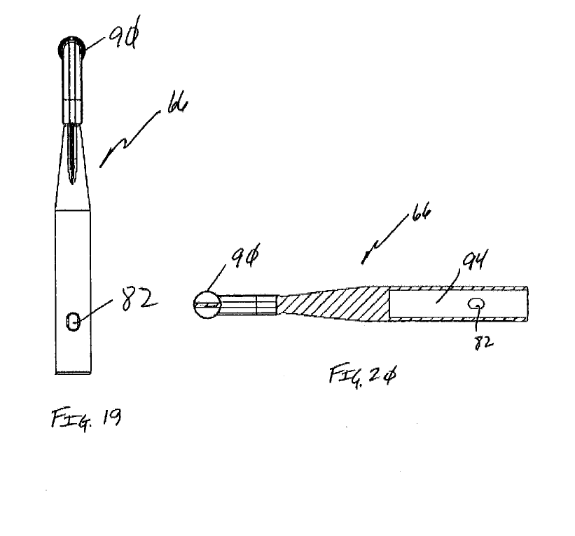

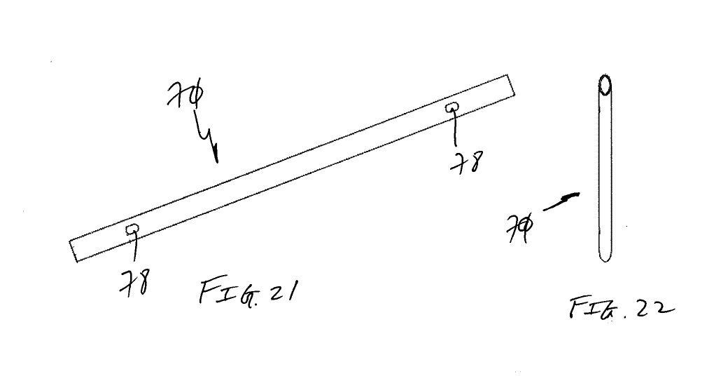

Referring now to FIGS. 15-20, the handle 66 of one embodiment of the present invention is shown. The handle 66 may include grips 90 in a generally tubular and, preferably, has an oblong shape to increase the bending stiffness thereof. The handle 66 includes an aperture 82 for receipt of a coupling (i.e. a spring loaded button) that is associated with a shaft 70, which will be described in further detail below. The handle also includes a cavity 94 for receiving the shaft 70. Again, one aperture 82 is shown, but a plurality of apertures may be included without departing from the scope of the invention.

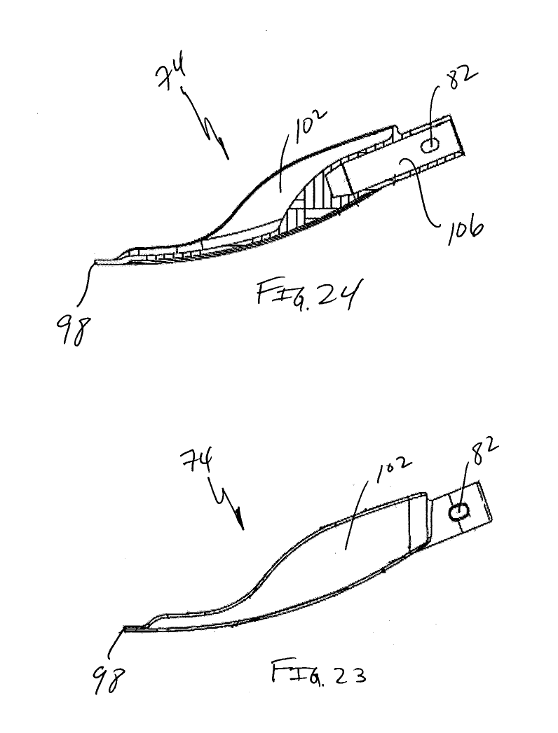

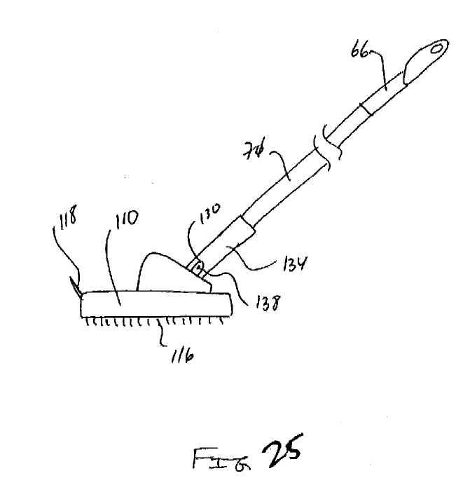

Referring now to FIGS. 21 and 22, one embodiment of the shaft 70 is shown. Here, the shaft 70 includes two coupling members 78, such as spring loaded buttons, for receipt within apertures associated with the handle and/or blade. Preferably, the shaft 70 is at least partially solid or reinforced between the coupling 78 and is oblong to increase the bending stiffness thereof.

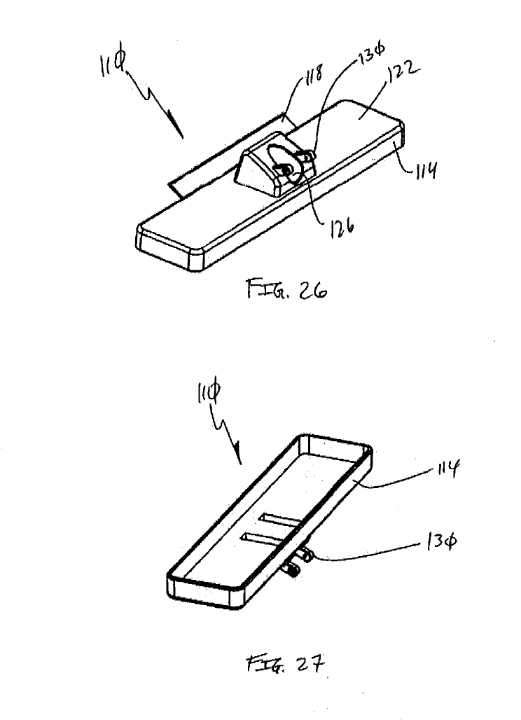

Referring now to FIGS. 23 and 24, one embodiment of the shovel blade 74 is shown. The blade 74 includes a leading edge 98 that may receive a protector as described above. The blade 74 includes sidewalls 102 that help maintain the amount of snow or other items carried within the blade 74. The blade 74 also includes a cavity 106 for receiving the shaft and associated aperture 82. The apertures 82 received a coupling associated with the shaft. One skilled in the art will appreciate that the cavity 106 may be elongated wherein additional apertures are included to allow the shaft to be interconnected to the blade at various locations, thereby allowing selective alterations of the shovel or broom length.

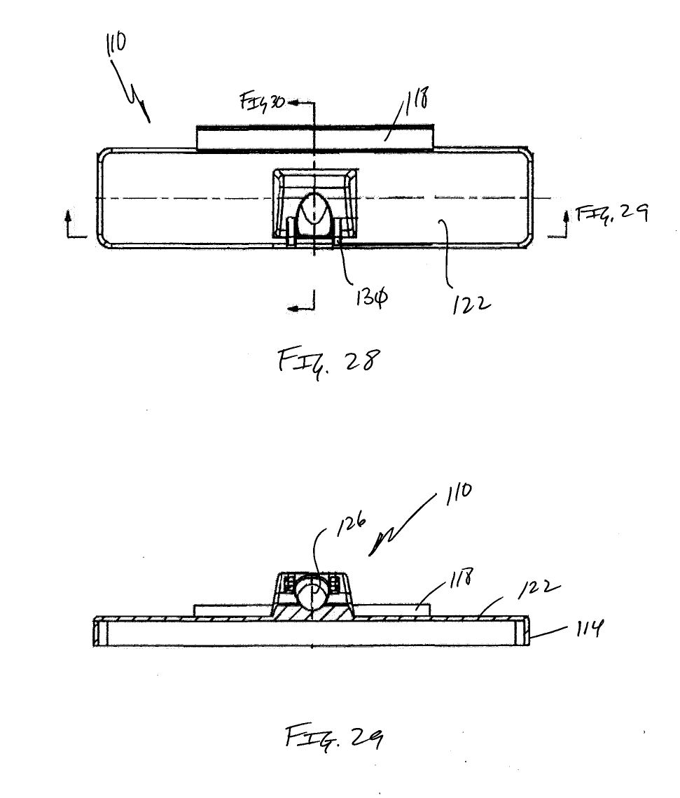

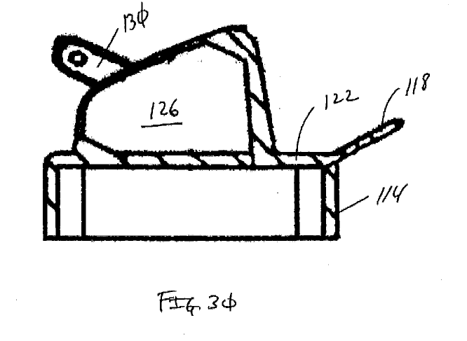

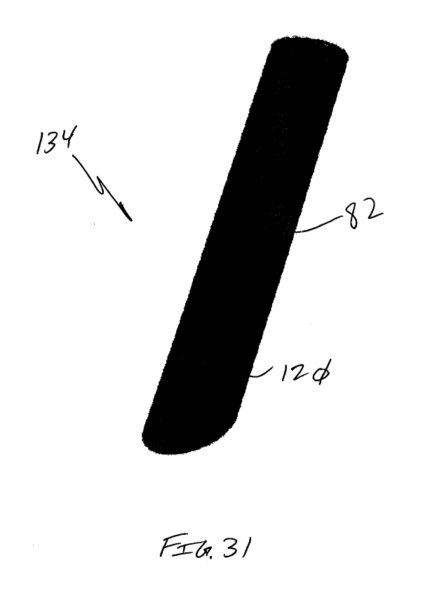

Referring now to FIGS. 25-30, a broom head 110 for use with the shaft 70 and handle 66 of one embodiment of the present invention is shown. The broom head 110 is generally a rectangular member having a lip 114 projecting therefrom that defines an area for receipt of a plurality of bristles 116. The broom head 110 also is associated with an ice scraper 118 that is positioned at an angle relative to an upper surface 122 of the broom head 110. Preferably, the angle of the ice scraper 118 relative to the upper surface 122 is about 100 degrees. The broom head 110 also includes a recess 126 for receipt of the shaft 70. The recess 126 may also be associated with a clevis 130 that locks a shaft adapter 134 for within the recess 126. In operation, a pin 138 would also be used to interconnect the clevis 130, and thus the broom head 110, to the adapter 134.

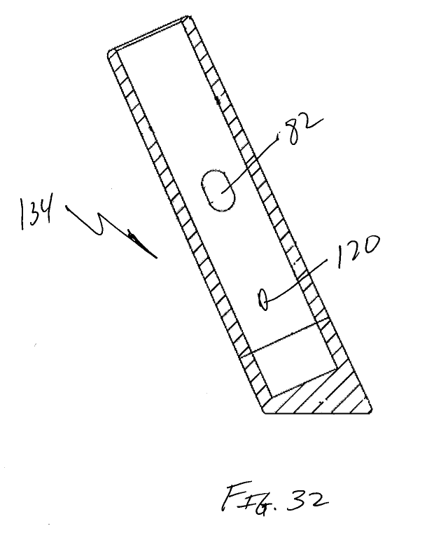

Referring now to FIGS. 31 and 32, the adapter 134 is shown that is used with the broom head of FIGS. 25-30. The adapter 34 is comprised of a generally hollow member having an aperture for receiving the coupling members of the shaft described above. In addition, a pin aperture 120 is provided that receives the pin that cooperates with the clevis 130 described above to maintain the adapter 134 within the recess of the broom head 110.

The components of the snow removal system may be made of any stiff material, such as plastic. Preferably, one embodiment of the present invention is fabricated at least partially of recycle plastic. The components may also be made of any color, such as dewalt yellow. It is contemplated one embodiment possesses surfaces of at least the shovel be made of a reflective material or include reflectors to enhance its use as a hazard indicator.

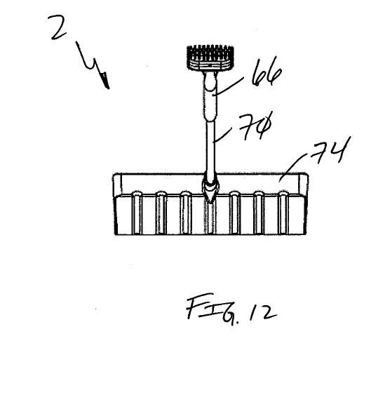

Referring specifically now to FIGS. 11-24, the shovel blade of one embodiment of the present invention is between about 13 and 14 inches deep and between about 18 and 19 inches wide. The length of an assembled shovel of one embodiment of the present invention is about 31 inches. The shaft of one embodiment of the present invention is between about 28 and 29 inches long having a major dimension of between about 1 to 2 inches and a minor dimension of about 0.75 inches, thereby defining an oblong cross sectional area.

Referring now to FIGS. 25-30, the broom head 110 of one embodiment is between about 18 to 19 inches in width and about 1.25 inches thick.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A collapsible tool, comprising:
a shaft having a first end and a second end;
a handle interconnected to said first end of said shaft; and
a broom head associated with said second end of said shaft, said broom head comprising an upper surface with a forward edge, a rearward edge and opposing lateral edges therebetween, said forward edge further including an ice scraper.

2. The device of claim 1, wherein said handle is associated with said broom head by way of an adapter.

3. The device of claim 2, wherein said shaft includes a first retractable coupling adjacent to said first end and a second retractable coupling adjacent to said second end, said first retractable coupling and said second retractable coupling interfacing with apertures in said handle and said adapter, respectively.

4. The device of claim 1, wherein said shaft includes a generally solid portion.

5. The device of claim 1, wherein said shaft possesses a continuous oblong cross section.

6. The device of claim 1, wherein said second end of said shaft is also adapted to receive a shovel blade.

7. The device of claim 1, wherein said broom head further comprises a lip that emanates from said upper surface.

8. The device of claim 2, wherein said adapter fits into a recess associated with a clevis and is held in place by a fastener that is associated with said clevis and said adapter.

9. A snow removal system, comprising:
a shaft having a first end and a second end;
a handle interconnected to said first end of said shaft;
a broom head for interconnection with said second end of said shaft, said broom head comprising an upper surface with a forward edge, a rearward edge and opposing lateral edges therebetween, said forward edge further including an ice scraper; and
a shovel blade for interconnection with said second end of said shaft.

10. The device of claim 9, wherein said handle is associated to said broom head by way of an adapter.

11. The device of claim 10, wherein said shaft includes a first retractable coupling adjacent to said first end and a second retractable coupling adjacent to said second end, said first retractable coupling and said second retractable coupling interfacing with apertures in said handle and said adapter, respectively.

12. The device of claim 9, wherein said shaft includes a generally solid portion.

13. The device of claim 9, wherein said shaft possesses a continuous oblong cross section.

14. The device of claim 9, wherein said broom head further comprises a lip that emanates from said upper surface.

15. The device of claim 10, wherein said adapter fits into a recess associated with a clevis of said broom head and is held in place by a fastener that is associated with said clevis and said adapter.
